(19) United States
(12) Patent Application Publication
(10) Pub. No.: US 2002/0071101 A1
(43) Pub. Date: Jun. 13, 2002

(54) Display system for image systems for the playback of medical images

(76) Inventors: Heinz Horbaschek, Erlangen (DE); Bernd Keuenhof, Kleinsendelbach (DE); Thomas Mertelmeier, Erlangen (DE)

Correspondence Address: SCHIFF HARDIN & WAITE, Patent Department, 6600 Sears Tower, 233 South Wacker Drive, Chicago, IL, 60606, US

(21) Appl. No.: 09/911,193

(22) Filed: Jul. 23, 2001

(30) Foreign Application Priority Data
Jul. 25, 2000 (DE) 10036143.9

(51) Int. Cl. G03B 21/26

(52) U.S. Cl. 353/28

(57) ABSTRACT

In a display system for image systems for the playback of medical images, a number of images are projected onto a passive imaging surface with a laser. The images are built up with a scan procedure. An arrangement is provided that acquires the attitude and position of the imaging surface relative to the laser and automatically sets a properly sized and attitudinally correct, distortion-free projection on the imaging surface.

### BACKGROUND OF THE INVENTION

1. Field of the Invention

The present invention is directed to a display system for image systems for playback of medical images.

2. Description of the Prior Art

Display systems of this type are used at medical workstations and picture archiving and communication system (PACS) consoles or in the operating room as socalled “monitor traffic signals” for the playback of medical images, for example X-ray images, whereby monitors are employed.

The presentation of medical images at PACS or workstation consoles usually ensues on a number of monitors, for example 2 through 6 monitors, so that these systems are very heavy and bulky and also exhibit a high heat emission. In the presentation on a number of monitors, moreover, a disturbing interspace arises between the individual monitor images. Large monitors and/or flat displays having image diagonals greater than 1 meter and satisfactory resolution do not currently exist.

Given employment of monitors in the operating room (OP), these are frequently hung from the ceiling and impede the physician's freedom of motion and free access to the patient in the intervention, since these systems are extremely heavy and bulky.

German OS 197 19 349 discloses a medical workstation with a projection playback apparatus that has a video projector. The video projector and the projection surfaces can be manually aligned relative to one another by adjustment means. This manual adjustment, however, is very complicated and cannot be achieved in the case of curved surfaces.

U.S. Pat. No. 5,376,007 discloses an apparatus for the implementation of teaching sessions for micro-surgical eye operations wherein the presentation of video images ensues with monitors and a projection monitor. The projection for the teaching sessions ensues with permanently installed devices.

German OS 195 44 068 discloses a method and an apparatus for the projection of a video image in a distortion-free manner on a screen having a controllable light beam and deflection unit.

### SUMMARY OF THE INVENTION

An object of the present invention is to provide a display system of the species initially described which avoids the aforementioned disadvantages.

This object is inventively achieved in a display system wherein a number of images are simultaneously projected onto at least one passive imaging surface in a serially adjacent configuration with a laser. The serially adjacent configuration can be substantially horizontal (i.e. side-by-side images) or substantially vertical (i.e. images one above the other). The images can be built up by a scanning procedure. An arrangement can be provided that acquires the attitude and position of the imaging surface with reference to the laser, and automatically sets a properly sized and attitudinally correct, distortion-free projection on the imaging surface. As a result thereof, monitors of workstations and PACS consoles are no longer required, for example in the operating room, since the images can be projected onto an arbitrary, white imaging surface.

The deflection of the laser beam can ensue, for example, by arranging a projector in front of the laser, the laser beams being deflected therewith and projected onto the imaging surface.

The laser can be connected to a display controller.

An intermediate storage and matching to different playback standards can ensue when a video image store is arranged between image system and display controller.

The different viewing directions can be taken into consideration in an embodiment wherein the display system has a number of different imaging surfaces and wherein a control device, with which the size and direction of the projections can be varied is connected to the projector.

Different incident angles of the laser beam onto the imaging surface can be compensated in an embodiment wherein a correction circuit is provided that eliminates geometrical distortion produced by individual positions of different imaging surface by means of a corresponding variation of the deflection of the projector.

A memory can be provided for dimensions of different imaging surfaces and their distances from the projector, so that the size and direction of the projection can be set when switching onto a selection imaging surface.

An automatic adaptation to the different imaging surfaces is achieved in an embodiment wherein one or more sensors acquire the positions of the imaging surfaces relative to the projector and a properly sized and attitudinally correct projection is set dependent on the lay of a selected imaging surface. A video camera can be employed as a sensor.

A playback unimpeded by attending persons can ensue when the projector is suspended from the ceiling.

The passive imaging surface can be a projection surface operated with reflected or directly transmitted light that hangs from the ceiling and/or can be a playback surface located at a medical apparatus, and it can have curved surfaces.

### DESCRIPTION OF THE DRAWINGS

FIG. 1 illustrates an inventive X-ray diagnostics installation having a laser display system.

FIG. 2 shows a circuit arrangement of the inventive laser display system of FIG. 1.

### DESCRIPTION OF THE PREFERRED EMBODIMENTS

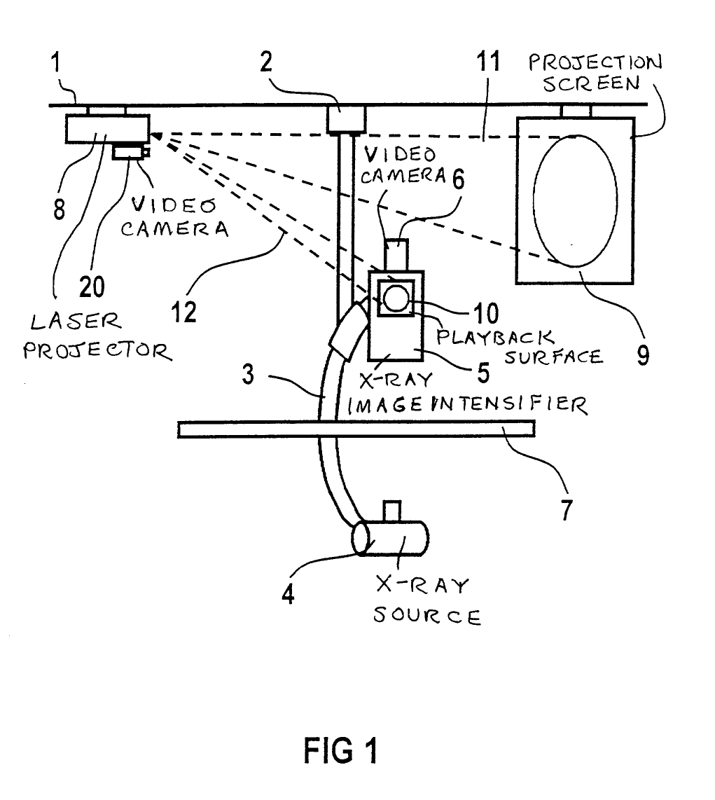

FIG. 1 shows an inventive X-ray diagnostic installation with a displaceable holder 2 attached to the ceiling 1 that holds a C-arm 3. An X-ray source 4 and, lying opposite it, an X-ray image intensifier 5 with a coupled video camera 6 or some other X-ray image transducer, for example a semiconductor detector, are attached to the ends of the C-arm 3. A patient positioning table 7 can be introduced into the beam path of the X-ray source 4. A projector 8 of a laser display system is likewise attached to the ceiling, the projector 8 reproducing images produced by the X-ray diagnostics installation on a projection screen 9 hanging from the ceiling. The projection can ensue with a technique reflected light or a directly transmitted light technique. A playback surface 10 onto which the X-ray images can be alternatively projected is provided at the X-ray apparatus, for example at the X-ray image intensifier 5. To that end, for example, the projector 8 projects either a large laser beam fan 11 onto the projection screen 9 or a small laser beam fan 12 onto the playback surface 10. The imaging surfaces 9 and 10 can have curved surfaces. Arbitrary light-colored surfaces, for example a wall or a sheet, can be employed as imaging surfaces.

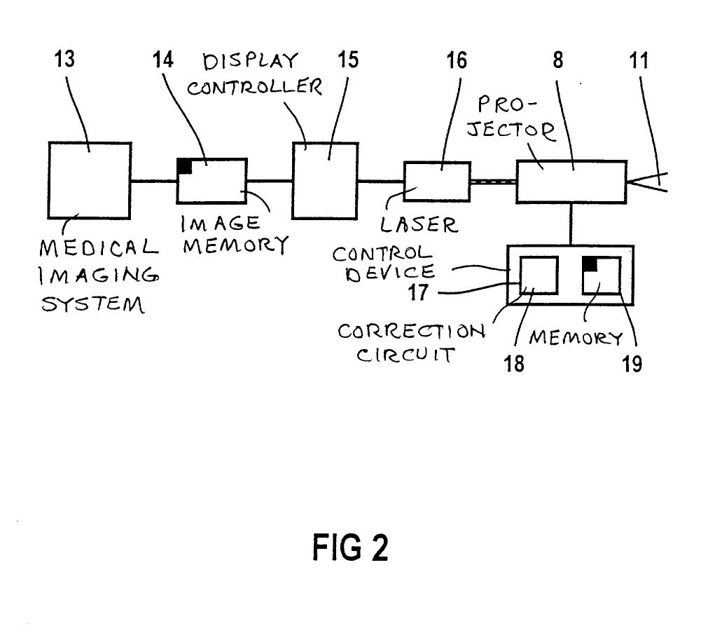

FIG. 2 shows the laser display system that can be utilized in a medical modality. Modalities of image-generating systems can be employed, for example, a CT unit for computer tomography, an MR unit for magnetic resonance, a DSA unit for digital subtraction angiography or an X-ray unit for digital radiography. The video signal of the medical image system 13 is intermediately stored in a video image store 14 and supplied to a display controller 15. This display controller 15 is connected to a laser 16 and controls the amplitude thereof. The laser 16 has the projector 8 placed in front of it, this effecting the deflection of the laser beam.

For building up the images by a scan procedure, the projector 8 has a deflection device for scanning that, for example, can be a holographic deflection device as disclosed, for example, in European Application 0 495 138. The scan beam generated by the laser is deflected and focused on the imaging surface 9 or 10 with an objective. The projection direction thus automatically follows the individual setting of the imaging surface.

A control device 17 with which the size of the laser beam fans 11 and 12 and their direction can be modified is connected to the projector 8, so that the images can be projected onto the different and differently sized imaging surfaces 9 and 10.

The control device 17 can have a correction circuit with which a distortion-correction of the projected image given a non-perpendicular position of the imaging surface relative to the central ray of the projector 8 is achieved by means of a pre-distortion in the projector 8.

Given topically highly different positions and sizes of the projection surfaces such as, for example, ceiling-hung screen 9 and playback surface 10 at the apparatus, an automatic size matching of the image also ensues after selection. For this purpose, the corresponding values for dimensions of different imaging surfaces 9 and 10 and their distances from the projector 8 can be stored in advance in a memory 19. The size and the direction of the projections are set when switching to a selected imaging surface 9 or 10.

The acquisition of the distance and lay of the projection surface relative to the projector can, for example, ensue by means of infrared distance sensors, with radar signals or by reception of the projected image with a sensor 20 at the projector 8 itself. As a result, the projection surface or area can be automatically adapted to the different imaging surfaces. For example, a video camera 20 can be utilized as a sensor.

The following advantages are achieved by the presentation of medical images with the inventive laser display system:

A number of images can be presented side-by-side and below one another in an arbitrary arrangement on a large display, the ergonomic division thereof being capable of being defined by the user.

A lower space requirement derives as a result of less of a structural depth. The laser can be situated in a side room, the projector, for example, hangs from the ceiling, whereby oblique positions are possible. The imaging surface, for example the projection screen 9, can be variably designed.

No gaps arise between the images when they are presented on a large screen.

There are no geometrical imaging errors as arise, for example, with CRT monitors.

A uniform sharpness distribution is independent of the image size.

Arbitrarily curved projection surfaces and arbitrary display sizes can be realized.

As a result of the inventive combination of a laser display and a medical imaging system, PACS consoles are obtained with a presentation of a plurality of images on a display and a projection display in the operating room are obtained in a simple and space-saving manner.

Although modifications and changes may be suggested by those skilled in the art, it is the intention of the inventors to embody within the patent warranted hereon all changes and modifications as reasonably and properly come within the scope of their contribution to the art.

We claim as our invention:

1. A display system for an image system for playback of medical images, comprising:
at least one passive imaging surface; and
a laser projector which projects a plurality of images simultaneously in a serially adjacent configuration onto said at least one passive imaging surface.

2. A display system as claimed in claim 1 wherein said laser projector projects said plurality of images in a substantially horizontal serially adjacent configuration.

3. A display system as claimed in claim 1 wherein said laser projector projects said plurality of images in a substantially vertical serially adjacent configuration.

4. A display system as claimed in claim 1 wherein said images are built up by a scan procedure.

5. A display system as claimed in claim 1 wherein said laser projector emits a laser beam, and further comprising a deflection arrangement disposed in a path of said laser beam for deflecting said laser beam onto said at least one imaging surface.

6. A display system as claimed in claim 1 further comprising a display controller connected to said laser projector for controlling projection of said plurality of images.

7. A display system as claimed in claim 6 further comprising a video image memory connected between said laser projector and said controller for storing said plurality of images.

8. A display system as claimed in claim 1 comprising a plurality of passive different imaging surfaces, and further comprising a control device connected to said laser projector for setting a selected size and direction of respective projections onto respective ones of said plurality of different imaging surfaces.

9. A display system as claimed in claim 8 wherein said different imaging surfaces have respective geometrical distortions associated therewith due to said different imaging surfaces being disposed at respectively different individual positions, and wherein said display system further comprises a correction unit connected to said laser projector for eliminating said geometrical distortions.

10. A display system as claimed in claim 9 wherein said different imaging surfaces have respectively different sizes and distances from said laser projector, and further comprising a memory connected to said laser projector in which said different sizes and dimensions are stored for use by said correction circuit.

11. A display system as claimed in claim 9 further comprising a sensor which identifies respective positions of said different imaging surfaces relative to said laser projector, said sensor supplying a signal to said correction circuit for correcting for said geometrical distortions.

12. A display system as claimed in claim 11 wherein said sensor is a video camera.

13. A display system as claimed in claim 1 wherein said laser projector comprises a laser source and a projector arrangement, said laser source being disposed remote from said projector arrangement.

14. A display system as claimed in claim 13 wherein said projector arrangement is adapted for suspension from a ceiling.

15. A display system as claimed in claim 1 wherein said at least one passive imaging surface has a curved surface.

16. A display system as claimed in claim 1 wherein said at least one passive imaging surface is adapted for suspension from a ceiling.

17. A display system as claimed in claim 1 wherein said at least one passive imaging surface is translucent and wherein said laser projector directly transmits light onto a back side of said at least one passive imaging surface.

18. A display system as claimed in claim 1 wherein said at least one passive imaging surface is a playback surface disposed at a medical device.

19. A display system for an image system for playback of medical images, comprising:
at least one passive imaging surface;
a laser projector which simultaneously projects a plurality of images onto said at least one passive imaging surface, said at least one passive imaging surface having an attitude and position relative to said laser projector; and
an arrangement connected to said laser projector for automatically setting said laser projector to project a properly sized and attitudinally correct and distortion-free projection of said plurality of images on said passive imaging surface.

20. A display system as claimed in claim 19 further comprising a display controller connected to said laser projector for controlling projection of said plurality of images.

21. A display system as claimed in claim 20 further comprising a video image memory connected between said laser projector and said controller for storing said plurality of images.

22. A display system as claimed in claim 19 comprising a plurality of passive different imaging surfaces, and further comprising a control device connected to said laser projector for setting a selected size and direction of respective projections onto respective ones of said plurality of different imaging surfaces.

23. A display system as claimed in claim 22 wherein said different imaging surfaces have respective geometrical distortions associated therewith due to said different imaging surfaces being disposed at respectively different individual positions, and wherein said display system further comprises a correction unit connected to said laser projector for eliminating said geometrical distortions.

24. A display system as claimed in claim 23 wherein said different imaging surfaces have respectively different sizes and distances from said laser projector, and further comprising a memory connected to said laser projector in which said different sizes and dimensions are stored for use by said correction circuit.
